(19) United States
(12) Patent Application Publication
(10) Pub. No.: US 2006/0252447 A1
(43) Pub. Date: Nov. 9, 2006

(54) TPC Command, SIR Estimation and Channel Estimation Improvement Using TPC Command History

(76) Inventors: Tarik Muharemovic, Dallas, TX (US); Sriram Sundararajan, Plano, TX (US); Vijay Sundararajan, Richardson, TX (US); Alan Gatherer, Richardson, TX (US)

Correspondence Address: TEXAS INSTRUMENTS INCORPORATED, P O BOX 655474, M/S 3999, DALLAS, TX, 75265, US

(21) Appl. No.: 11/381,414

(22) Filed: May 3, 2006

Related U.S. Application Data
(60) Provisional application No. 60/677,471, filed on May 3, 2005.

(51) Int. Cl. H04B 7/00; H04Q 7/20

(52) U.S. Cl. 455/522

(57) ABSTRACT

In this invention the base station utilizes a history of previous TPC commands to provide more deterministic channel behavior. This enables better generation of future TPC commands, SIR estimates and channel estimates. Prior solutions don't utilize previous TPC decisions. This invention provides enhances SIR estimation, channel estimation and power control.

### TECHNICAL FIELD OF THE INVENTION

The technical field of this invention is transmitted power control in a wireless communications system.

### BACKGROUND OF THE INVENTION

A wireless communication system includes a fixed base station and one or more portable stations. In this system the base station can transmit a transmitter power control (TPC) command to each mobile unit. This TPC command is typically made to maintain a level of signal to interference ratio (SIR). If the received SIR at the base stations is low, a TPC command to the mobile unit to increase transmitted power would increase the SIR. If the received SIR at the base station is above a minimum acceptable level, a TPC command to the mobile unit to decrease transmitted power would tend to decrease the SIR. A decrease in transmitted power would tend to reduce sources of interference with other communication and increase battery life at the mobile unit.

The inventors are unaware of any proposed algorithm that utilizes the fact that the mobile acts predictably upon receiving the TPC command. In K. Higuchi, H. Andoh, K. Okawa, M. Sawahashi, and F. Adachi, “Experimental evaluation of combined effect of coherent Rake combining and SIR-based fast transmit power control for reverse link of DS-CDMA mobile radio,” IEEE J. Select. Areas Commun., vol. 18, pp. 1526-1535, Aug. 2000, channel estimation is weighted multislot averaging (WMSA). The channel estimates at the base station are computed over multiple slots, but with predetermined scaling factors used to weight channel estimates over slots. In this reference the base station does not utilize the fact that mobile unit previously altered its transmit power based on TPC commands from the base station.

### SUMMARY OF THE INVENTION

In this invention the base station utilizes a history of previous TPC commands to provide more deterministic channel behavior. This enables better generation of future TPC commands, SIR estimates and channel estimates. Prior solutions don't utilize previous TPC decisions. This invention provides enhances SIR estimation, channel estimation and power control.

### BRIEF DESCRIPTION OF THE DRAWINGS

These and other aspects of this invention are illustrated in the drawings, in which:

FIG. 1 illustrates a base station and plural mobile units used in this invention; and

FIG. 2 illustrates in flow chart form the base station operation in this invention.

### DETAILED DESCRIPTION OF PREFERRED EMBODIMENTS

This invention will be described in connection with uplink transmission user capacity. However, the same principle is valid for downlink transmission. The preferred embodiment of this invention performs uplink transmission in universal mobile terrestrial system (UMTS). The UMTS typically consists of a data channel and a control channel. In UMTS, the Dedicated Physical Data CHannel (DPDCH) is a data portion of the Dedicated CHannel (DCH). The Dedicated Physical Control CHannel (DPCCH) is the control portion of DCH.

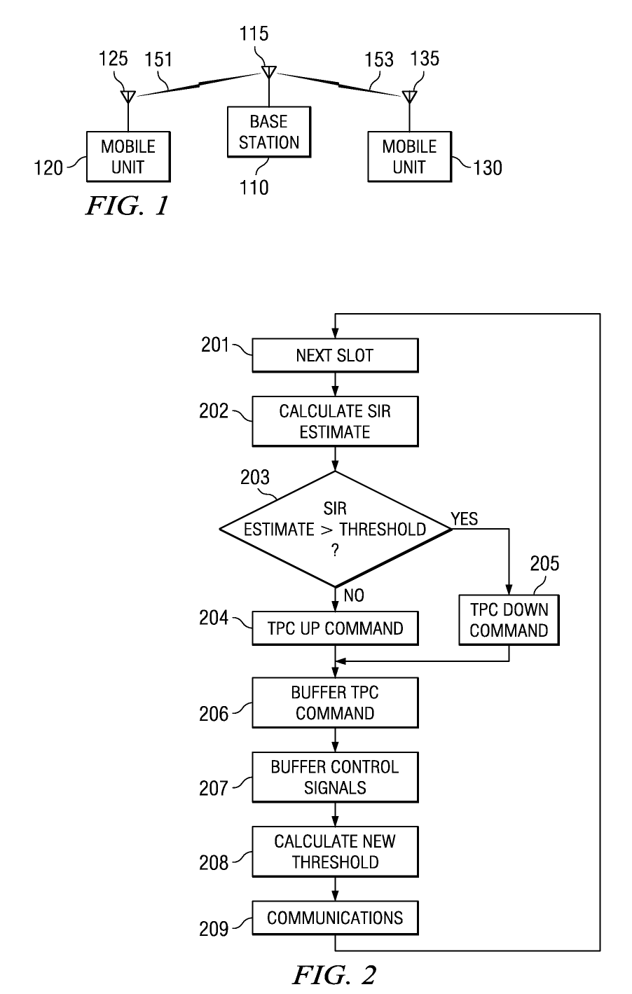

FIG. 1 illustrates a base station and plural mobile units used in this invention. Base station 110 includes antenna 115. Base station 110 communications with plural mobile units 120 and 130 having respective antennas 125 and 135 via radio frequency links 151 and 153. FIG. 1 illustrates only two mobile units 120 and 130 but those skilled in the art would realize that this invention is usable when base station 110 communicates with more than two mobile units via corresponding radio frequency links.

Base station 110 utilizes a control channel in radio frequency links 151 and 153 to perform Channel Estimation and SIR estimation. Base station 110 sends a fast TPC (Transmit Power Control) command to mobile units 120 and 130. Base station 110 selects the TPC command by comparing the SIR estimate with a predetermined threshold. This power control update takes place once per time slot allocated that that mobile unit according to UMTS. Each such slot is 0.667 milliseconds. The TPC is a one bit up or down command. Upon reception of this TPC command, the corresponding mobile unit 120 or 130 adjusts its transmit power by a predetermined step size in decibels. Thus the mobile unit acts predictably after receiving the TPC command.

Base station 110 maintains two buffers. The first buffer stores previous TPC commands which base station 110 sent for several previous time slots. The depth of this buffer in number of time slots is selected based upon on how many time slots are necessary to implement the algorithm. The second buffer stores symbols from previous time slots from the control channel. This second buffer includes both pilots and non-pilots. Base station 110 may keep only one buffer storing a combination of the data mentioned above depending on the particular algorithm implemented.

FIG. 2 illustrates a flow chart of base station 110 operation according to this invention. This flow chart begins by consideration of the next time slot (processing block 210) in the UMTS technique. Next base station 110 calculates a SIR estimate for communication with the corresponding mobile unit 120 or 130 (processing block 202). Test block 230 compares this SIR estimate with a threshold. If the SIR estimate is not greater than the threshold (No at test block 203), then block 204 determines to sent a TPC up command. This up command informs the mobile unit of the current slot to increase transmitted power. Such an increase would tend to increase the SIR estimate in the next slot. If the SIR estimate is greater than the threshold (Yes at test block 203), then block 205 determines to sent a TPC down command. This down command informs the mobile unit of the current slot to decrease transmitted power. Such a decrease would tend to decrease the SIR estimate in the next slot. These separate steps tend to direct the transmitted power of the mobile unit corresponding to the current slot to an optimum transmitted power level. That is, transmitted power is generally raised until an acceptable SIR estimate is reached under conditions of low SIR estimates. This increases the likelihood of successful communication. Under conditions of excess SIR estimate transmitted power is generally lowered. This tends to lower battery consumption at the mobile unit and reduce interference with other slots.

Base station 110 stores the TPC command in a buffer (processing block 206) and further stores other control signals in a separate or combined buffer (processing block 207). Base station 110 then calculates a new threshold (processing block 208) for test block 203 on the next occurrence of the current slot. This calculation is based upon the stored prior TPC commands (block 206) and the stored control signals (block 207).

Base station 110 communicates with the mobile unit corresponding to the current slot (processing block 209). In the preferred embodiment this communication is in accordance with universal mobile terrestrial system (UMTS) standard via the Dedicated Physical Data CHannel (DPDCH) and the Dedicated Physical Control CHannel (DPCCH) of the Dedicated CHannel (DCH). In the preferred embodiment the data is telephone voice communications. However, this invention is equally applicable to data in the form of short text messages, emails and any other digital communications.

Retaining the data in the two buffers aids computing the SIR estimation, the next TPC command or the channel estimation. Several algorithms, such as the Wiener filter, may be used for estimating any of these.

What is claimed is:

1. A method of wireless communication between a base station and at least one mobile unit comprising the steps of:
calculating an estimated Signal to Interference Ratio (SIR) for a particular communication;
comparing the estimated SIR to a threshold;
transmitting a power command to increase transmitted power from the base station to the mobile unit if said estimated SIR is not greater than said threshold;
transmitting a power command to decrease transmitted power from the base station to the mobile unit if said estimated SIR is greater than said threshold;
storing a history of prior power commands;
updating the threshold based upon said stored history of prior power commands.

2. The method of claim 1, further comprising the step of:
storing a history of other control signals transmitted from the base station to the mobile unit; and
wherein said step of updating the threshold is further based upon said stored history of other control signals.

3. The method of claim 1, further comprising:
performing said steps of calculating an estimated Signal to Interference Ratio (SIR), comparing the estimated SIR to a threshold, transmitting a power command to increase transmitted power, transmitting a power command to decrease transmitted power, storing a history and updating the threshold successively for a plurality of mobile units.
